(19) United States
(12) Patent Application Publication
(10) Pub. No.: US 2010/0072937 A1
(43) Pub. Date: Mar. 25, 2010

(54) MOBILE POSITIONING STRUCTURE FOR AN AXIAL ROD MOTOR

(76) Inventors: HONG-CHUN TENG, Taichung Industrial Park (TW); Yu-Tzu Ku, Taichung Industrial Park (TW)

Correspondence Address: Dr. BANGER SHIA, 102 Lindencrest Ct., Sugar Land, TX, 77479-5201, US

(21) Appl. No.: 12/238,430

(22) Filed: Sep. 25, 2008

(51) Int. Cl. G05B 1/08

(52) U.S. Cl. 318/640

(57) ABSTRACT

A mobile positioning structure for an axial rod motor comprises a base on which being disposed a stator, and on the stator is disposed a mover on which being mounted an optical signal reader. The stator is provided with a plurality of measurement marks. The position of the mover on the stator is read by the cooperation of an optical reader and measurement marks, such an optical signal reading method is not affected by the magnetic field. Hence, the data detected will be more accurate with less error.

### BACKGROUND OF THE INVENTION

1. Field of the Invention

The present invention relates to a positioning device usually used on laser boring machine, small milling machine, image detecting instruments, etc, and more particularly to a mobile positioning structure for an axial rod motor.

2. Description of the Prior Art

Currently, there are many control structures for controlling the movement and position of a mechanism, and different control structures have different characteristics. The present invention is aimed at the improvement of the axial rod motor. At present, the conventional axial rod motor essentially comprises, as shown in FIG. 7, a base 10, a stator 11, a mover 12, a reader 13 and a magnetic scale 14. At each of two ends of the base 10 is defined a support portion 101. The stator 11 is a cylindrical rod inside which is disposed magnetic members. Both ends of the stator 11 are jointed to the support portions 101 of the base 10, and the middle of the stator 11 is suspended. The mover 12 is movably inserted on the middle of the stator 11 and is provided with coils which are connected with a power source and will produce a magnetic field after being electrified. The reader 13 is mounted on the mover 12 for reading the magnetic scale 14. The magnetic scale 14 is mounted on the base 10 and extends axially along with the stator 11.

After the mover 12 is electrified and produce a magnetic field, a driving force will be produced between the mover 12 and the stator 11 to drive the mover 12 to move back and forth along the stator 11, and the displacement and position of the mover 12 is detected by the cooperation of the reader 13 on the mover 12 with the magnetic scale 14.

However, detecting the displacement and position of the mover 12 by the cooperation of the reader 13 and the magnetic scale 14 will have the following problems: since the mover 12 on the stator 11 is moved by the magnetic force produced by the magnetic members and the electrified coils, such an arrangement will produce a strong and great magnetic field. The magnetic scale 14 also provides data to the reader 13 based on magnetic induction. Therefore, in a comparatively small space, the magnetic scale 14 is too close to the stator 11 and mover 12 and is susceptible to the influence of the magnetic field thereof, resulting in an error or incorrectness in reading the data.

The present invention has arisen to mitigate and/or obviate the afore-described disadvantages.

### SUMMARY OF THE INVENTION

The primary objective of the present invention is to provide a mobile positioning structure for an axial rod motor, wherein the position of the mover on the stator is read by the cooperation of an optical reader and measurement marks, such an optical signal reading method is not affected by the magnetic field. Hence, the data detected will be more accurate.

The mobile positioning structure for an axial rod motor provided by the present invention comprises: a base, a stator, a mover and an optical signal reader. The base is provided for mounting the stator. The stator is an elongated cylindrical rod in which being disposed magnetic members, around an outer surface of the stator are equidistantly arranged plural measurement marks. The mover, inside which being provided coils which are connected with a power source and will produce a magnetic field after being electrified, is movably inserted on the stator. The optical signal reader disposed on the mover and provided with an optical receiver chip.

### BRIEF DESCRIPTION OF THE DRAWINGS

FIG. 1 is an assembly view of a mobile positioning structure for an axial rod motor in accordance with the present invention;

FIG. 2 is a side view of the mobile positioning structure for an axial rod motor in accordance with the present invention;

FIG. 3 is a partially amplified view of FIG. 2;

FIG. 4 is an illustrative view showing that how the position of the mover is detected and controlled;

FIG. 5 shows that the measurement marks are plural equidistantly arranged annular lines which are parallel to one another;

FIG. 6 the measurement marks are formed by a helical curve with equal pitches; and

FIG. 7 shows a conventional positioning structure.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

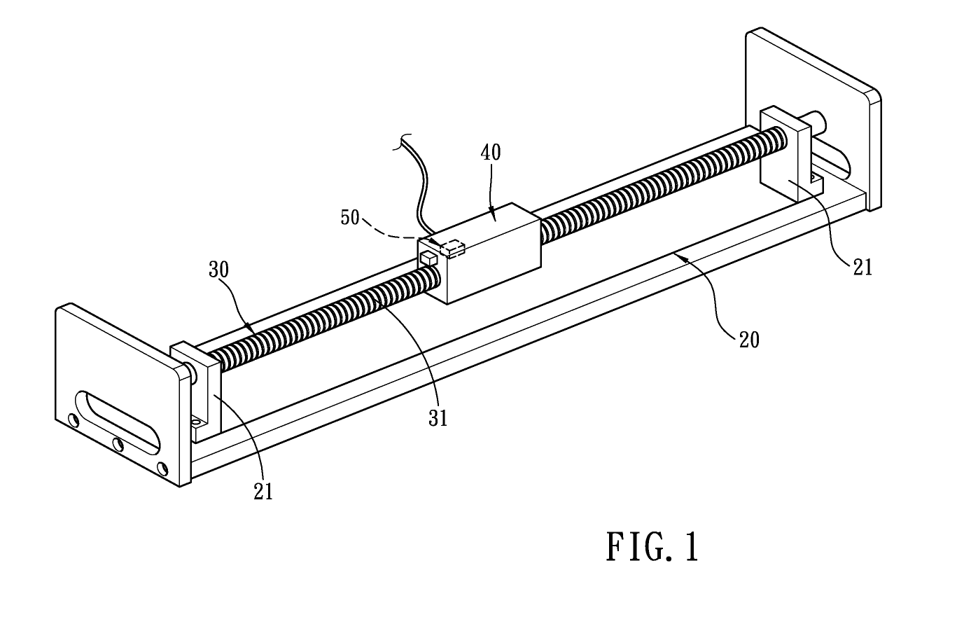

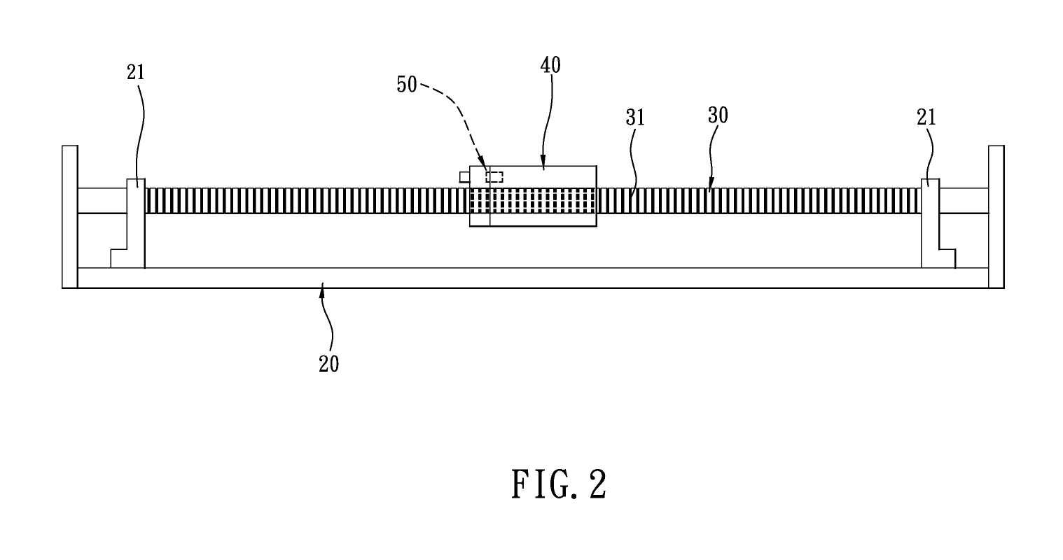

Referring to FIGS. 1 and 2, an axial rod motor in accordance with the present invention comprises: a base 20, a stator 30, a mover 40 and an optical signal reader 50.

The base 20 is provided with two opposite support portions 21.

The stator 30 is an elongated cylindrical rod in which being disposed a plurality of magnetic members, so the stator 30 has magnetic properties. Around the outer surface of the stator 30 are equidistantly arranged plural measurement marks 31 which are made by machining or laser cutting. Two ends of the stator 30 are jointed to the support portions 21 of the base 20, respectively, and the middle of the stator 30 is suspended.

Inside the mover 40 is provided coils which are connected with a power source and will produce a magnetic field after being electrified. The mover 40 is inserted on the stator 30 and moves between both ends thereof.

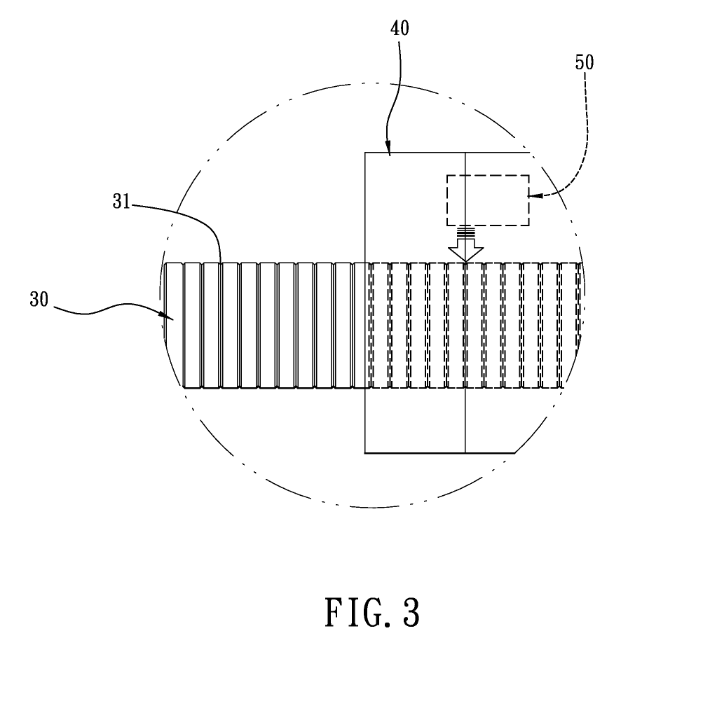

The optical signal reader 50 is disposed on the mover 40, as shown in FIG. 3, and is provided with an optical receiver chip which is used to receive the read-out signal and amplified signal of the optical signal reader 50. The optical signal reader 50 and the measurement marks 31 will produce an A-phase and B-phase sine waves which have a phase difference of approximately 90 degrees.

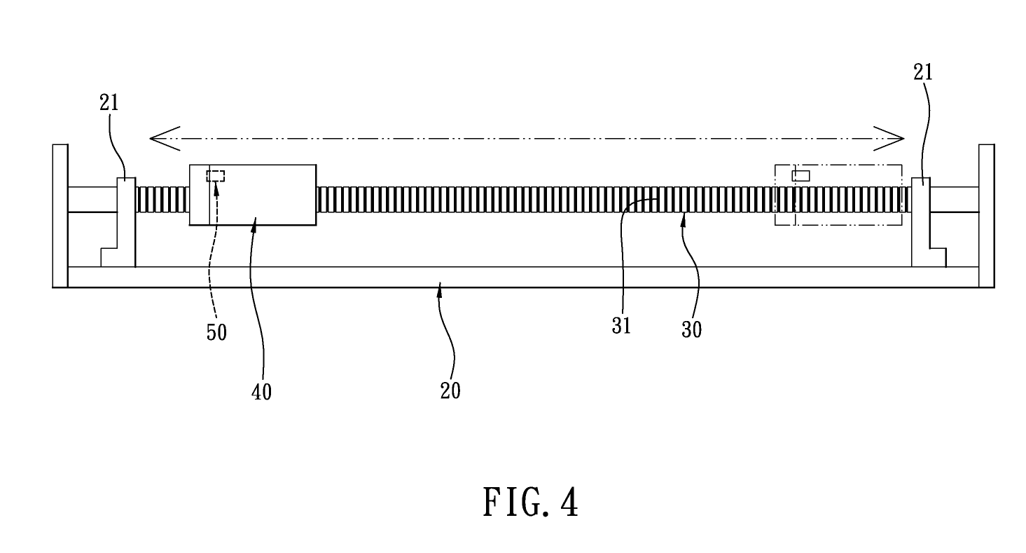

Referring then to FIGS. 3 and 4, the mover 40 will produce a magnetic field after being electrified, and its positive and negative electrodes will cooperate with the magnetic members of the stator 30 to produce left and right driving forces. The optical signal reader 50 will read the measurement marks 31 on the stator 30 and provide amplified signal to the optical receiver chip. Based on the intervals of the marks 31, the position of the optical signal reader 50 and the mover 40 can be worked out precisely for better precise position determination and control.

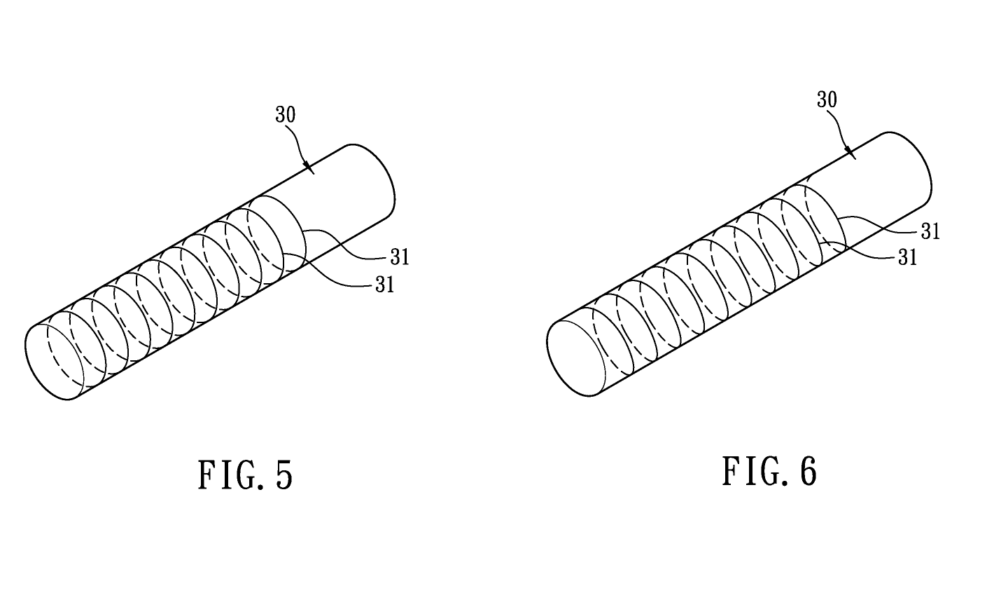

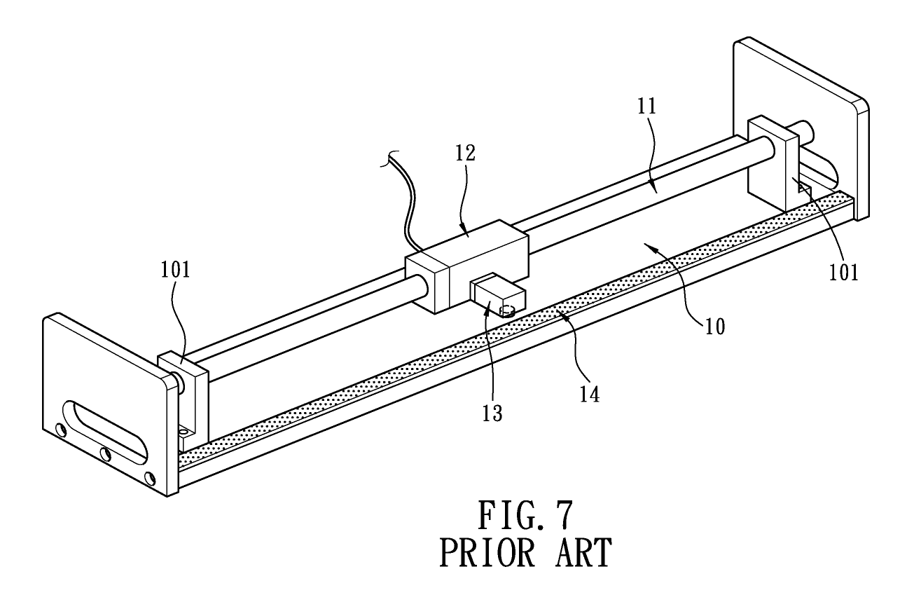

The measurement marks 31 are plural equidistantly arranged annular lines which are parallel to one another, as shown in FIG. 5, or the marks 31 can be a helical curve with equal pitches, as shown in FIG. 6.

With the abovementioned arrangements, the present invention has the following advantages: it utilizes the cooperation of the optical signal reader 50 and the measurement marks 31 to control and detect the position of the mover 40 on the stator 30, such an optical signal reading method is not affected by the magnetic field. Hence, the data detected will be more accurate.

While we have shown and described various embodiments in accordance with the present invention, it is clear to those skilled in the art that further embodiments may be made without departing from the scope of the present invention.

What is claimed is:

1. A mobile positioning structure for an axial rod motor, comprising:
a base provided with two opposite support portions;
a stator being an elongated cylindrical rod in which being disposed a plurality of magnetic members to enable the stator to have magnetic properties, around an outer surface of the stator being equidistantly arranged plural measurement marks, two ends of the stator being jointed to the support portions of the base, respectively, and the middle of the stator being suspended;
a mover, inside which being provided coils which are connected with a power source and will produce a magnetic field after being electrified, the mover being movably inserted on the stator; and
an optical signal reader disposed on the mover and provided with an optical receiver chip.

2. The mobile positioning structure for an axial rod motor as claimed in claim 1, wherein the measurement marks are made by laser cutting.

3. The mobile positioning structure for an axial rod motor as claimed in claim 1, wherein the measurement marks are made by machining.

4. The mobile positioning structure for an axial rod motor as claimed in claim 1, wherein the measurement marks are plural equidistantly arranged annular lines which are parallel to one another.

5. The mobile positioning structure for an axial rod motor as claimed in claim 1, wherein the measurement marks are formed by a helical curve with equal pitches.

6. The mobile positioning structure for an axial rod motor as claimed in claim 1, wherein the optical signal reader and the measurement marks will produce an A-phase and B-phase sine waves which have a phase difference of 90 degrees.

7. The mobile positioning structure for an axial rod motor as claimed in claim 4, wherein the optical signal reader and the measurement marks will produce an A-phase and B-phase sine waves which have a phase difference of 90 degrees.

8. The mobile positioning structure for an axial rod motor as claimed in claim 5, wherein the optical signal reader and the measurement marks will produce an A-phase and B-phase sine waves which have a phase difference of 90 degrees.
